(19) United States
(12) Patent Application Publication
(10) Pub. No.: US 2008/0259242 A1
(43) Pub. Date: Oct. 23, 2008

(54) POLARIZED LIGHT EMITTING DEVICE

(75) Inventors: Toru Chiba, Tokyo (JP); Takanobu Shiokawa, Kanagawa (JP); Yukio Kubota, Saitama (JP); Hiroki Yamazaki, Saitama (JP); Takaomi Sekiya, Tokyo (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 12/017,504

(22) Filed: Jan. 22, 2008

(30) Foreign Application Priority Data
Jan. 23, 2007 (JP) 2007-012627

(51) Int. Cl. G02F 1/13357; F21V 9/14

(52) U.S. Cl. 349/62; 362/19

(57) ABSTRACT

A polarized light emitting device has a planar emitting device, a phase-shift device, a polarizing reflecting device, and a reflecting device. The planar emitting device emits light from a front and back surfaces of the planar emitting device. The phase-shift device transmits the light emitted from said planar emitting device, and changes the polarization direction of the light. The polarizing reflecting device transmits or reflects the light according to the polarization of the light emitted from the front surface or transmitted by said phase-shift device. The reflecting device reflects the light emitted from the back surface or transmitted by said phase-shift device.

### BACKGROUND OF THE INVENTION

1. Field of the Invention

The present invention relates to a polarized light emitting device that emits light having a particular polarization.

2. Description of the Related Art

A polarized light emitting device is used as the light source of an image display device. The image display device presents images on its display area. The display area uses polarized light emitting devices.

The polarized light emitting devices emit light with a particular polarization direction. The light emitted from the polarized light emitting device is irradiated to a liquid crystal shutter. The liquid crystal shutter transmits or blocks the light on the basis of the light polarization.

The polarized light emitting device comprises a light source, a polarizing plate used for emitting light having a particular polarization from a polarized light emitting device, and a diffusing plate used for evenly emitting light from the surface of a polarized light emitting device. The polarizing plate transmits only the light having a particular polarization, and reflects light having other polarizations. As a means of increasing the amount of emitted light from a polarized light emitting device, a light-guiding plate which polarizes reflected light and guides it to the polarizing plate again is disclosed in the United States Patent Published Application Number 20040141108A1.

### SUMMARY OF THE INVENTION

The light-guiding plate is provided across the width of a polarized light emitting device so that light enters it from across the width. This increases the distance between the adjacent polarized light emitting devices because the light-guiding plate is provided between the polarized light emitting devices.

The greater distance results in longer unremitting areas on the display, and the increased luminance of images shown on the display, so consequently the polarized light emitting device may not emit evenly.

Moreover, the thicker diffusing plate needed for the polarized light emitting device to emit equally increases the thickness of the image display device.

An object of the present invention is to provide a polarized light emitting device which has high luminous efficiency, a thin profile, and emits evenly.

### BRIEF DESCRIPTION OF THE DRAWINGS

The objects and advantages of the present invention will be better understood from the following description, with reference to the accompanying drawings in which:

FIG. 1 shows the polarized light emitting device according to the first embodiment of the present invention;

FIG. 2 shows the optical paths in the polarized light emitting device as the first embodiment of the present invention;

FIG. 3 shows the polarized light emitting device as the second embodiment of the present invention;

FIG. 4 shows the optical paths in the polarized light emitting device as the second embodiment of the present invention;

FIG. 5 shows the optical paths in the polarized light emitting device as the second embodiment of the present invention;

FIG. 6 is a schematic sectional view showing an image display device having polarized light emitting devices;

FIG. 7 is a schematic sectional view showing a first field sequential display device having the polarized light emitting devices;

FIG. 8 is a schematic view of the polarized light emitting devices with the color filters showing from the emitting surfaces of the polarized light emitting devices;

FIG. 9 is a schematic view of the color filters and the liquid crystal shutters showing from the emitting surfaces of the polarized light emitting devices;

FIG. 10 is a schematic sectional view showing a second field-sequential display device having the polarized light emitting devices;

FIG. 11 is a partially enlarged view showing the image display device having the polarized light emitting devices;

FIG. 12 is a partially enlarged view showing the image display device having the polarized light emitting devices; and

FIG. 13 is a partially enlarged view showing the image display device having the polarized light emitting devices.

### DESCRIPTION OF THE PREFERRED EMBODIMENTS

The present invention is described below with reference to the embodiments shown in the drawings.

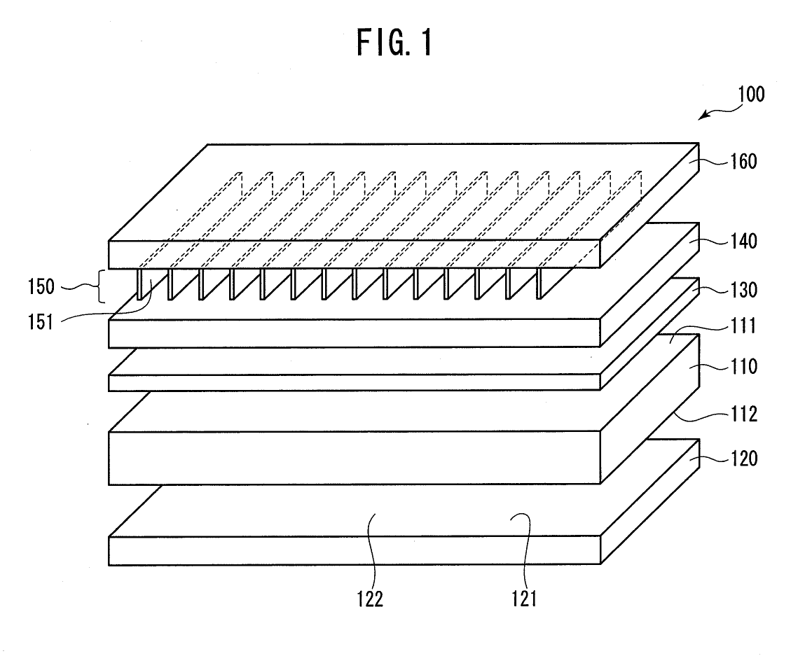

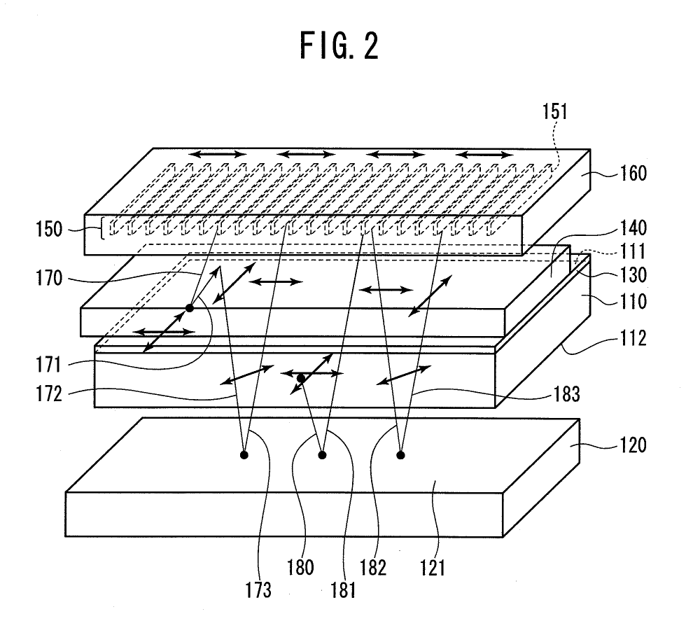

The embodiment of the polarized light emitting device is described with reference to FIGS. 1 and 2.

The polarized light emitting device 100 comprises an organic EL (Electro Luminescence) luminous layer 110. A transparent electrode 130 is in close contact with front surface 111 of the organic EL luminous layer 110. A quarter-wave plate 140, a wire grid 150, and a base plate 160 are provided on the surface of the transparent electrode 130. A facing electrode 120 (the first electrode) and a reflecting plate 122 are provided on a back surface of the organic EL luminous layer 110. The facing electrode 120 has high optical reflectance so that it functions as a reflecting plate.

The luminous layer 110 is transparent. Both the front surface 111 and the back surface 112 emit light having various polarization directions. Polarization direction is created by two perpendicular components, i.e. light is resolved into two perpendicular components. The quarter-wave plate 140 shifts the phase of one of the components a quarter wavelength so that the polarization direction of the light is changed. That is, linearly-polarized light is changed to elliptically-polarized light, and vice-versa. The transparent electrode 130 is transparent, and provides electric power to the organic EL luminous layer 110. A wire grid 150 is provided on base plate 160. The wire grid 150 has wires 151 which are aligned parallel to each other on the base plate 160 at certain distances. Light having an electrical field with direction orthogonal to the longitudinal direction of wires 151 is transmitted through the wire grid 150. Light with an electrical field whose direction is parallel to the longitudinal direction of the wires 151 is reflected by the wire grid 150. One surface of the facing electrode 120, which is in close contact with the organic EL luminous layer 110, combines the facing electrode surface 121 and the reflecting surface 122. This surface may be formed of any conductive material such as aluminum alloy or silver, and must have high optical reflectance. The facing electrode 121 delivers electrons to the organic EL luminous layer 110. That is, the facing electrode 121 has a function of a ground. The reflecting surface 122 reflects the light emitted by the organic EL luminous layer 110.

The function of the polarized light emitting device 100 in the first embodiment is described with reference to FIG. 2. FIG. 2 shows the optical paths in the polarized light emitting device according to the first embodiment. The light emitted by the front surface of the organic EL luminous layer 110 follows these optical paths.

Light rays 170 and 171 which are emitted from the front surface 111 of the organic EL luminous layer 110 are incident on the quarter-wave plate 140, and are phase shifted by a quarter wavelengths by the quarter-wave plate 140. The quarter-wave plate 140 thus gives the lights 170 and 171 a quarter wavelength phase difference. Linearly polarized light is thereby changed to circularly polarized light, and vice-versa. The polarized light then strikes the wire grid 150. Light rays 170 having an electrical field perpendicular to the longitudinal direction of wires 151 within the incident light pass through the wire grid 150.

Light rays 171 with a polarization not perpendicular to the longitudinal direction of wires 151 are reflected by the wire grid 150 and strike the quarter-wave plate 140 where they are polarized into light rays 172 and directed to the transparent electrode 130. Light rays 172 pass through the transparent electrode 130 and the organic EL luminous layer 110, and illuminate the facing electrode surface 121 becoming light 173. The light 173 is reflected by the reflecting plate 122 provided on the facing electrode surface 121. The reflected light 173 which passes through the organic EL luminous layer 110 and the transparent electrode 130, is incident on the quarter-wave plate 140, and is then re-polarized.

Light passing through the quarter-wave plate 140 is incident on the wire grid 150. The light having an electrical field perpendicular to the longitudinal direction of the wires 151 passes through the wire grid 150 and the transparent circuit board 160, and exits the polarized light emitting device 100.

The light having an electrical field which is not perpendicular to the longitudinal direction of the wires 151 is reflected by the wire grid 150, and polarized by the quarter-wave plate 140. By a succession of such steps, the light can pass through the wire grid 150, and exits the polarized light emitting device 100.

Light 180 emitted from the back surface 112 of the organic EL luminous layer 110 illuminates the facing electrode 121. The light is reflected by the reflecting plate 122 which is provided on the facing electrode surface 121. The reflected light 181 passes through the organic EL luminous layer 110 and the transparent electrode 130, is incident on the quarter-wave plate 140, and then re-polarized by the quarter-wave plate 140. The polarized light is incident on the wire grid 150. Incoming light with an electrical field perpendicular to the longitudinal direction of the wires 151 passes through the wire grid 150.

Incoming light 181 with an electrical field not perpendicular to the longitudinal direction of the wires 151 is reflected by the wire grid 150, and polarized by the quarter-wave plate 140. The polarized light passes through the organic EL luminous layer 110 and the transparent electrode 130, and is then reflected by the reflecting plate 122 which is provided on the facing electrode surface 121. The reflected light 183 passes through the organic EL luminous layer 110 and the transparent electrode 130, is polarized by the quarter-wave plate 140 again, and strikes the wire grid 150.

This light passes through the quarter-wave plate 140 three times after being emitted from the back surface 112 of the organic EL luminous layer 110. Therefore, it is phase-shifted by three-fourths of a wavelength. The phase difference between the orthogonally oscillating components in this light differs from that of the light emitted by the organic EL luminous layer 110. Light having a polarization perpendicular to the longitudinal direction of the wires 151 passes through the wire grid 150 and the transparent circuit board 160, exiting the polarized light emitting device 100.

Light having a polarization not perpendicular to the longitudinal direction of wires 151, is reflected by the wire grid 150, and polarized by the quarter-wave plate 140. By a succession of such steps, the light can pass through the wire grid 150, and exits the polarized light emitting device 100.

Light having a polarization direction which can not pass through the wire grid 150, is polarized repeatedly until it can pass through the wire grid 150, permitting efficient utilization of the light emitted by the organic EL luminous layer 110, and increasing the light intensity of the polarized light emitting device 100.

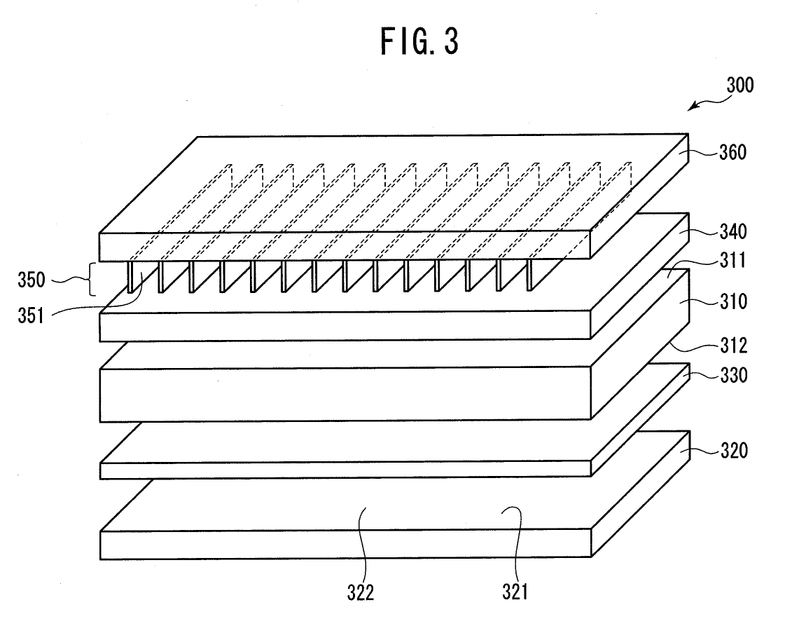

The function of the polarized light emitting device 300 in the second embodiment is described with reference to FIGS. 3-5. Descriptions of the structures similar to the first embodiment are omitted.

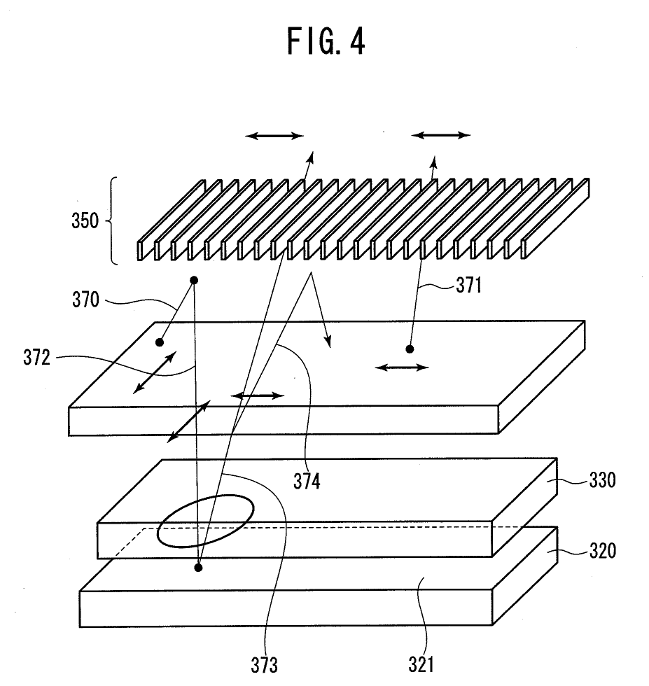

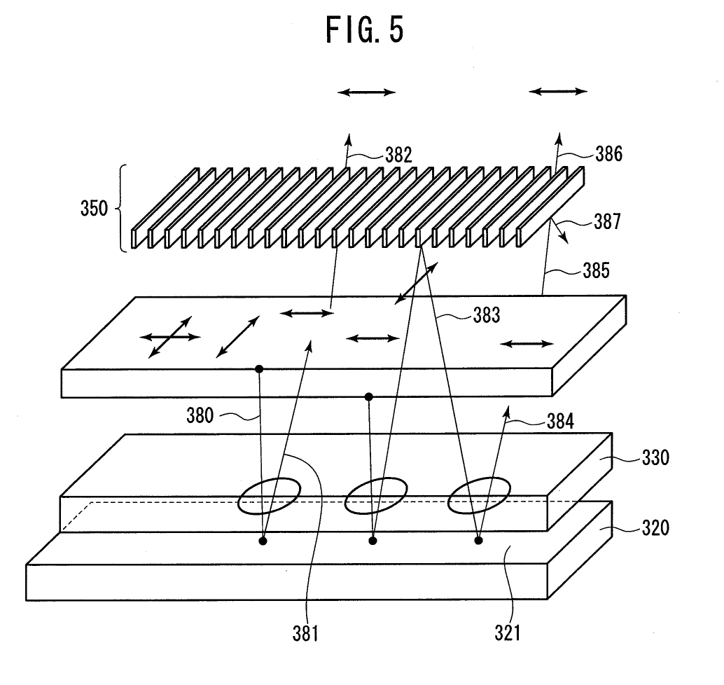

FIG. 4 shows the optical paths of the light emitted by the front surface of the organic EL luminous layer. FIG. 5 shows the optical paths of the light emitted by the back surface of the organic EL luminous layer.

In this embodiment, the quarter-wave plate 330 is provided between the organic EL luminous layer 310 and the facing electrode 320.

The light 370 emitted from the front surface 311 of the organic EL luminous layer 310 passes through the transparent electrode 340, and then strikes the wire grid 350. The light 371 having an electrical field perpendicular to the longitudinal direction of wires 351 passes through the wire grid 350.

The incoming light 372 having an electrical field not perpendicular to the longitudinal direction of wires 351 is reflected by the wire grid 350, strikes the quarter-wave plate 140, and passes through the transparent electrode 340. The light 372 passes through the organic EL luminous layer 310 and strikes the quarter-wave plate 330. The quarter-wave plate 330 polarizes the incoming light. The light passing through the quarter-wave plate 330 illuminates the facing electrode 320. The light is reflected by the reflecting plate 322, and is incident on the quarter-wave plate 330. The incoming light 373 is polarized again by the quarter-wave plate 330. That is, the light 373 has a polarization direction created by shifting the phase difference π for the light emitted by the front surface 311 of the organic EL luminous layer 310.

The light passing through the quarter-wave plate 330 passes through the organic EL luminous layer 310 and the transparent electrode 340, and then strikes the wire grid 350. The light 373 having an electrical field perpendicular to the longitudinal direction of wires 351, passes through the wire grid 350 and the transparent circuit board 360, and exits the polarized light emitting device 300.

The light 374 having an electrical field not perpendicular to the longitudinal direction of wires 351, is reflected by the wire grid 350, and polarized by the quarter-wave plate 330. In such a succession of steps, the light 374 is able to pass through the wire grid 350, and exits the polarized light emitting device 300.

The light 380 emitted by the underside surface 312 strikes the quarter-wave plate 330 and is polarized. The light 380 passing through the quarter-wave plate 330 is reflected by the facing electrode 320 and strikes the quarter-wave plate 330 again. The light 381 is polarized by the quarter-wave plate 330 again, and passes through the organic EL luminous layer 310 and the transparent electrode 340, and then strikes the wire grid 350. Once light rays 382 among the incident light 381 have an electrical field perpendicular to the longitudinal direction of wires 351, they pass through the wire grid 350.

Light rays 383 having a polarization which is not perpendicular to the longitudinal direction of wires 351 is reflected by the wire grid 350, and directed to the transparent electrode 340. The light 383 passing through the transparent electrode 340 and the organic EL luminous layer 310 strikes the quarter-wave plate 330. The quarter-wave plate 330 shifts the polarization direction of the light 383 by α/2. The shifted light is reflected by a reflecting plate 322 which is provided on the facing electrode surface 320. The reflected light 384 passes through the organic EL luminous layer 310 and then strikes the quarter-wave plate 330. The polarization direction of the incoming light is shifted by the quarter-wave plate 330 by π/2 again. That is, this light has a polarization direction determined by shifting the phase of the light emitted by the organic EL luminous layer 310 by 2π.

The light 385 passing through the quarter-wave plate 330 passes through the organic EL luminous layer 310 and the transparent electrode 340, and is then incident on the wire grid 350. The light 386 having a polarization perpendicular to the longitudinal direction of wires 351, passes through the wire grid 350 and transparent circuit board 360, and exits the polarized light emitting device 300.

The light 387 having an electrical field which is not perpendicular to the longitudinal direction of the wires 351, is reflected by the wire grid 350, and polarized by the quarter-wave plate 330. By such a succession of steps, the light 374 can pass through the wire grid 350, and exits the polarized light emitting device 300.

The light having a polarization direction which can not pass through the wire grid 350 is polarized repeatedly until it can pass through the wire grid 350. The light emitted by the organic EL luminous layer 310 is thereby utilized efficiently, and the light intensity of the polarized light emitting device 300 is increased.

Since it is not necessary to provide a light emitting device perpendicular to the light emitting direction, the polarized light emitting device 300 may have a wider light emitting surface. That is, the ratio of the light emitting area to the projected area of the polarized light emitting device is increased so that the amount of emitted light per unit area in the image display is increased.

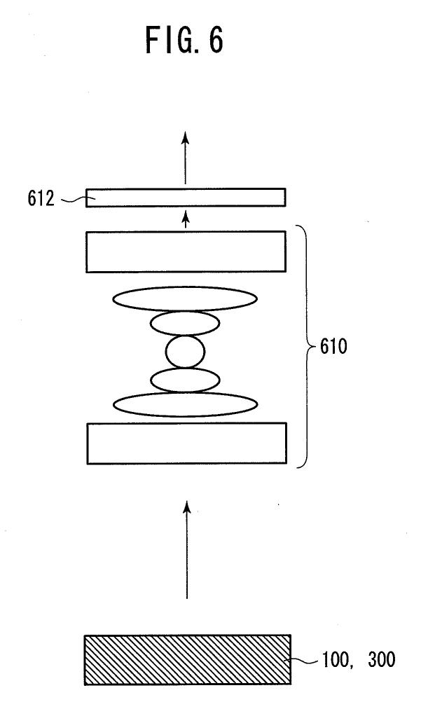

An image display device implementing the first or second polarized light emitting devices 100 or 300 is described with reference to FIG. 6.

The organic EL luminous layer provided in the polarized light emitting devices 100 and 300 emits white light. The wire grids 150 and 350 are provided on the back surface of the polarized light emitting devices 100 and 300, repeatedly. A liquid crystal shutter 610 is provided on the front surface 111 and 311 of the polarized light emitting devices 100 and 300. A color filter 612 is provided on the liquid crystal shutter 610. The liquid crystal shutter 610 transmits or blocks the light emitted by the polarized light emitting devices 100 and 300 according to the timing of a displayed moving image. The color filter 612 has red, green, and blue filters which decide the color of the emitted light passing through the liquid crystal shutter 610 red, green, and blue. The colored lights are emitted from the outside of the image display device.

An image display device which is thin and evenly illuminated is provided herewith.

Note that the color of the light emitted by the organic EL luminous layer is not limited to white, it may be monochromatic. The image display device has the color of the light emitted by the color filter.

Note that the organic EL luminous layer may emit the monochromatic light and the image display device may omit the color filters. In this case, the image display device will have the color of the light emitted by the organic EL luminous layer.

Alternatively, the color filter may be composed of monochromatic filters colored by one of red, green, or blue. The image display device can emit single color light.

The first field sequential display device having the first or second polarized light emitting devices 100 or 300 is described with reference to FIG. 6-9.

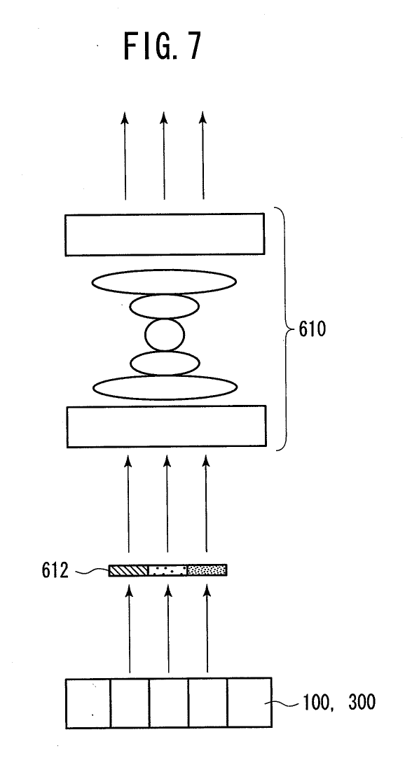

FIG. 7 is a schematic sectional view showing the first field sequential display device.

In the first field sequential display device, the first or second polarized light emitting devices 100 or 300 illuminates the color filter 612. The light passing through the color filter 612 exits the first field sequential display device after adjustment of its light amount by the liquid crystal shutter 610.

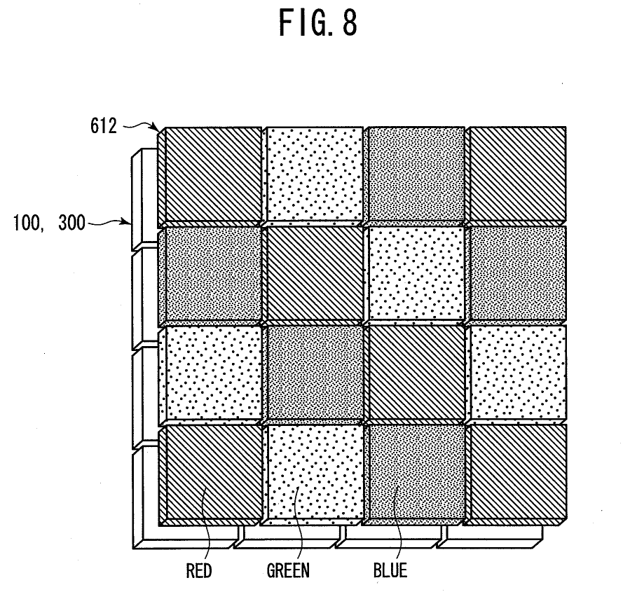

As shown in FIG. 8, the polarized light emitting devices 100 and 300 are each provided with the color filters 612. When the display device displays images, all polarized light emitting devices corresponding to picture elements assigning the color red in a given image emit white light. The white light is stripped of all frequencies except red by the color filter 612. Thus red light is emitted onto the liquid crystal shutter. By performing this process for blue and green as well, all three colors are projected onto the liquid crystal shutter in turn.

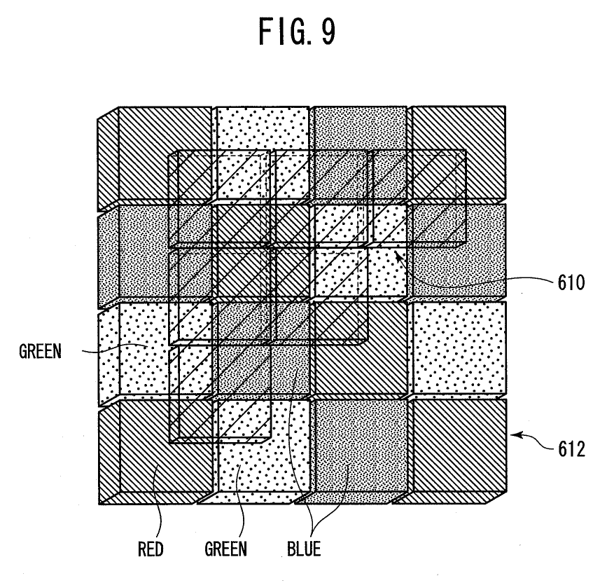

As shown in FIG. 9, the liquid crystal shutter 610 rests below four color filters 612 so that the color filter corners are situated at the center of the liquid crystal shutter. Thus, all three colors lights strike on one liquid crystal shutter 610.

The liquid crystal shutter 610 adjusts the brightness of the three colored lights transmitted by the color filter 612, and outputs the three colored lights to the outside of the display device. These processes are performed at a sufficiently high rate for viewers to perceive a color which is the mixture of the three colors when an image is presented. In other words, the display is capable of representing a gamut of colors.

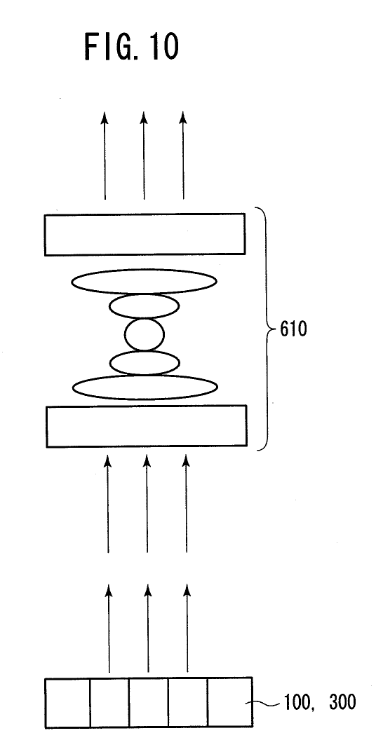

The second field-sequential display device having the first or second polarized light emitting devices 100 or 300 is described with reference to FIG. 10. The descriptions for the structures similar to the first field sequential display device are omitted.

The polarized light emitting devices 100 and 300 emit three colors, red, green, and blue, and do not have the color filter 612. When the display device displays images, all polarized light emitting devices which correspond to picture elements having red in the images emit red light. This red light is incident on the liquid crystal shutter 610. By executing these processes for the polarized light emitting devices 100 and 300 which emit blue and green light as well, three colors are projected onto the liquid crystal shutter in the sequence, red, blue, and green.

This display device is thinner and less expensive than the conventional devices, because the filters are not needed.

Note that in the second field-sequential display device, a color filter may be provided between the polarized light emitting devices 100 or 300 and the liquid crystal shutter 610. The purity of the emitting light color is thereby refined.

Moreover, in the first and second field sequential display devices, the liquid crystal shutter may be placed not across the four color filters, but wherever the three color lights coincident with the required intensity.

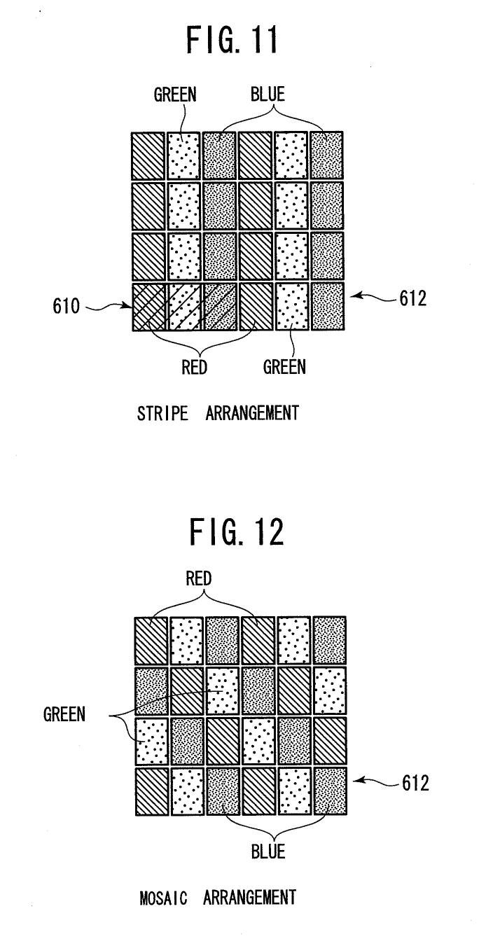

FIGS. 11 to 13 show arrangements of the polarized light emitting devices 100 and 300 and the color filter 612 in the first and second field-sequential display device.

In FIG. 11, the polarized light emitting devices 100 or 300, or the color filter 612 are provided in a stripe arrangement so that they make columns for each emitted color. The liquid crystal shutter 610 may be provided to cover the three color filters 610.

In FIG. 12, the polarized light emitting devices 100 or 300, or the color filter 612 are provided in a mosaic arrangement of a parallel lines running diagonally across the polarized light emitting devices 100 and 300 for each emitted color.

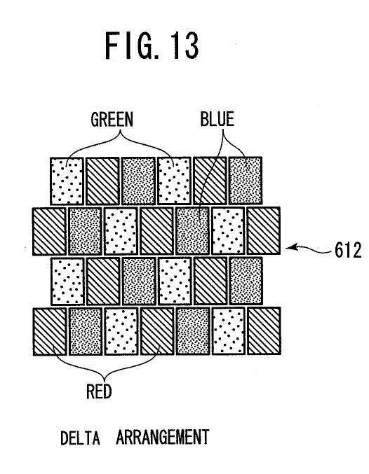

In FIG. 13, the polarized light emitting devices 100 or 300 or the color filter 612 are provided in a delta arrangement.

The field-sequential display device can display images with high sharpness and chromaticity by virtue of the polarized light emitting devices.

Note that, the facing electrode and the reflecting plate may consist of materials other than aluminum alloy or silver, such as other materials with high electrical conductivity and high reflectivity, respectively.

The liquid crystal shutter may also be omitted from the image display device. The image display device may thereby perform faster and display a higher definition image because the switching speed of the organic EL luminous layer is faster than that of the liquid crystal shutter.

Although the embodiment of the present invention has been described herein with reference to the accompanying drawings, obviously many modifications and changes may be made by those skilled in the art without departing from the scope of the invention.

The present disclosure relates to subject matter contained in Japanese Patent Application No. 2007-012627 (filed on Jan. 23, 2007), which is expressly incorporated herein, by reference, in its entirety.

1. A polarized light emitting device comprising:
a planar emitting device that emits light from its front and back surfaces;
a phase-shift device that transmits the light emitted from said planar emitting device, and changes the polarization direction of the light;
a polarizing reflecting device that transmits or reflects the light according to the polarization of the light emitted from the front surface or transmitted by said phase-shift device; and
a reflecting device that reflects the light emitted from the back surface or transmitted by said phase-shift device.

2. The polarized light emitting device according to claim 1, wherein said phase-shift device is provided between the front surface and said polarizing reflecting device.

3. The polarized light emitting device according to claim 1, wherein said phase-shift device is provided between the back surface and said reflecting device.

4. The polarized light emitting device according to claim 2, further comprising a second electrode that is provided between said front surface and said polarizing reflecting device to provide power to said planar emitting device,
wherein said reflecting device comprises a first electrode that provides power to said planar emitting device, and a surface of said reflecting device which faces said back surface reflects light.

5. The polarized light emitting device according to claim 4, wherein said polarizing reflecting device is provided on a base plate which transmits light.

6. The polarized light emitting device according to claim 1, wherein said phase-shift device is a quarter-wave plate.

7. The polarized light emitting device according to claim 1, wherein said planar emitting device is an organic EL luminous device.

8. The polarized light emitting device according to claim 1, wherein said polarizing reflecting device is a wire grid polarizing device.

9. An image displaying device comprising the polarized light emitting devices according to claim 5, comprising a liquid crystal shutter that is provided in each of said polarized light emitting devices, and said liquid crystal shutter transmits or blocks the light emitted by said polarized light emitting device.

10. The image displaying device according to claim 9, wherein said liquid crystal shutter has a back surface on which said polarized light emitting device is provided, and a front surface on which a color filter is provided.

11. The image displaying device according to claim 10, wherein said color filter has a color which is any one of red, green, or blue.

12. An image displaying device comprising the polarized light emitting devices according to claim 5, comprising a color filter that is provided on a surface from which said polarized light emitting devices emits light.

13. The image displaying device according to claim 12, wherein said color filter has a color which is any one of red, green, or blue.

14. The image displaying device comprising the polarized light emitting device according to claim 13, further comprising a liquid crystal shutter that is provided on a front surface of said color filter,
wherein said polarized light emitting device is provided on a back surface of said color filter, and said liquid crystal shutter transmits or blocks the light emitted by said polarized light emitting device.

15. An image displaying device comprising the polarized light emitting devices according to claim 5, wherein said planar emitting device emits any one of red, green, or blue color light.

16. The image displaying device according to claim 15, further comprising a liquid crystal shutter that is provided in each said polarized light emitting devices, and said liquid crystal shutter transmits or blocks the light emitted by said polarized light emitting device.

17. The image displaying device according to claim 14, wherein said color filter or said polarized light emitting device is provided in a stripe arrangement so that said color filter or said polarized light emitting device has lines of each emitted color.

18. The image displaying device according to claim 14, wherein said color filter or said polarized light emitting device is provided in a mosaic arrangement so that said color filter or said polarized light emitting device has parallel lines running diagonally across the polarized light emitting device for each emitted color.

19. The image displaying device according to claim 14, wherein said color filter or said polarized light emitting device is provided in a delta arrangement for each emitted color.

20. The polarized light emitting device according to claim 3, further comprising a second electrode that is provided between said front surface and said polarizing reflecting device to provide power to said planar emitting device,
wherein said reflecting device comprises a first electrode that provides power to said planar emitting device, and a surface of said reflecting device which faces said back surface reflects light.

21. The image displaying device according to claim 16, wherein said color filter or said polarized light emitting device is provided in a stripe arrangement so that said color filter or said polarized light emitting device has lines of each emitted color.

22. The image displaying device according to claim 16, wherein said color filter or said polarized light emitting device is provided in a mosaic arrangement so that said color filter or said polarized light emitting device has parallel lines running diagonally across the polarized light emitting device for each emitted color.

23. The image displaying device according to claim 16, wherein said color filter or said polarized light emitting device is provided in a delta arrangement for each emitted color.
